(19) United States
(12) Patent Application Publication
(10) Pub. No.: US 2021/0024748 A1
(43) Pub. Date: Jan. 28, 2021

(54) BENZOXAZINE RESIN COMPOSITION, PREPREG, AND FIBER-REINFORCED COMPOSITE MATERIAL

(71) Applicant: Toray Industries, Inc., Tokyo (JP)

(72) Inventors: Benjamin Lehman, Tacoma, WA (US); Benjamin Rutz, Tacoma, WA (US); Nobuyuki Arai, Tacoma, WA (US)

(73) Assignee: Toray Industries, Inc., Tokyo (JP)

(21) Appl. No.: 16/971,381

(22) PCT Filed: Mar. 19, 2019
(86) PCT No.: PCT/IB2019/000263

§ 371 Date: Aug. 20, 2020

Related U.S. Application Data
(60) Provisional application No. 62/650,489, filed on Mar. 30, 2018.
(60) Provisional application No. 62/810,671, filed on Feb. 26, 2019.

(51) Int. Cl. C08L 79/04; C08J 5/24

(52) U.S. Cl. CPC C08L 79/04; C08J 2463/00; C08J 2379/04; C08J 5/24

(57) ABSTRACT

A benzoxazine resin composition for a fiber-reinforced composite material is provided which contains at least a component [A] having a peak reaction temperature and a component [B] having a peak reaction temperatures that may be within 50° C. of each other. Component [A] includes at least one multifunctional benzoxazine resin. Component [B] includes at least one cycloaliphatic epoxy resin represented by Formula (I):

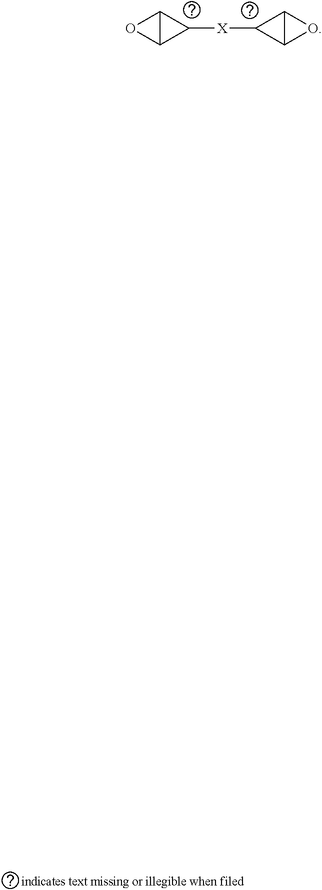

This benzoxazine resin composition is useful in the molding of fiber-reinforced composite materials. More particularly, it is possible to offer a benzoxazine resin composition for a fiber-reinforced composite material where the cured material obtained by heating having superior performance in extreme use environments, such as high temperature and high moisture.

### CROSS-REFERENCE TO RELATED APPLICATIONS

This is the U.S. National Phase application of PCT/IB2019/000263, filed Mar. 19, 2019 which claims priority to U.S. Provisional Application No. 62/650,489, filed Mar. 30, 2018, and U.S. Provisional Application No. 62/810,671, filed Feb. 26, 2019. The disclosures of each of these applications are incorporated herein by reference in their entirety for all purposes.

### FIELD OF THE INVENTION

The present invention relates to a benzoxazine resin composition, a prepreg, and a fiber-reinforced composite material, e.g., a carbon fiber-reinforced composite material. More specifically, the present disclosure provides a benzoxazine resin composition for use in fiber-reinforced composite materials which has superior performance in extreme use environments, such as high temperature and high moisture.

### BACKGROUND OF THE INVENTION

Fiber-reinforced composite materials comprising reinforcing fiber and a matrix resin are light weight and possess outstanding mechanical properties, so they are widely used in sports, aerospace, and general industrial applications.

Methods for producing fiber-reinforced composite materials include methods in which an uncured matrix resin is infused into reinforcing fiber to form a sheet-form prepreg intermediate, followed by curing, and resin transfer molding methods in which liquid-form resin is made to flow into reinforcing fiber that has been placed in a mold to produce an intermediate, followed by curing. With those methods that employ prepregs, the fiber-reinforced composite material is normally obtained by hot-pressing subsequent to layering multiple sheets of prepreg. The matrix resin that is used in the prepreg is commonly a thermosetting resin, in view of productivity considerations.

Phenol resins, melamine resins, bismaleimide resins, unsaturated polyester resins, epoxy resins, and the like have been used as the thermosetting resin. However, from the standpoint of improving moisture resistance and heat resistance, investigations have been progressing in recent years concerning the use of benzoxazine resins as matrix resins in fiber-reinforced composite materials as disclosed in International Pat. Pub. No. WO 2003018674.

However, most multifunctional benzoxazine resins have melting points around or above room temperature and high viscosities. These properties give benzoxazine resins the disadvantage of poor tackiness and draping properties when used as a matrix material for prepreg in combination with reinforcing fiber. Moreover, curing benzoxazine resins requires a lengthy time of 3 hours at a high temperature of at least 200° C., which yields a brittle material with poor toughness and low glass transition temperature when considering the cure temperature.

Not to be bound by theory, it is generally accepted that brittle materials, i.e., materials having low toughness and elongation, suffer from reduced tensile strength when used in fiber-reinforced composite materials. Thus, it is preferred that a thermoplastic compound be added to the benzoxazine resin composition in order to improve tensile strength and fracture toughness in composite applications. As adding a thermoplastic compounds also increases the viscosity of the benzoxazine resin when the thermoplastic compound is fully dissolved (the ideal case for improving the aforementioned properties), it is essential that a reactive diluent be added to the formulation to reduce the viscosity of the benzoxazine resin. In general, the viscosity of the benzoxazine resin composition should be between 1 and 50,000 poise when the temperature is between 25° C. to 100° C. If the benzoxazine resin composition is intended for use using the hot melt method of prepregging, the viscosity should be between 10 and 10,000 poise when the temperature is between 60° and 100° C. In the present invention viscosity refers to the complex viscoelastic modulus n* as measured at a frequency of 0.5 Hz and a gap length of 1 mm using a dynamic viscoelastic measuring device (ARES, manufactured by TA Instruments) and circular parallel plates 40 mm in diameter as the temperature is monotonically increased at a rate of 2° C./min.

Multifunctional glycidyl epoxy resins that are liquids at 40° C. have been effectively used as reactive diluents for benzoxazines, as disclosed in U.S. Pat. Pub. No. 20150141583. These epoxies are ideal reactive diluents for benzoxazines because they are effective at reducing the viscosity of benzoxazine resin, thermoplastic compounds can easily be dissolved in them, and they increase the crosslink density of the cured matrix, thereby improving the glass transition temperature over that of neat benzoxazine resin. Unfortunately, while they typically improve the glass transition temperature over neat benzoxazine resin, the glass transition temperature of glycidyl epoxy/benzoxazine resins is poor, especially after moisture conditioning, compared to other thermosetting resins such as cyanate esters and bismaleimides. This means that glycidyl epoxy/benzoxazine resins also have poor modulus retention at elevated temperatures, especially after moisture conditioning.

Including a cycloaliphatic epoxy resin in a resin composition can reduce the viscosity, decrease the water absorption, reduce the UV degradation, and increase the glass transition temperature relative to a benzoxazine resin composition containing only glycidyl type epoxy resins, as disclosed in U.S. Pat. Pub. No. 20150376406. However, in the case of U.S. Pat. Pub. No. 20150376406, the cycloaliphatic epoxies used to reduce the viscosity also reduce the glass transition temperature of the cured matrix because of their flexible aliphatic backbone containing an ester linkage. In addition, the flexible aliphatic backbone also significantly reduces the modulus of the resin after moisture conditioning, even when it is tested 20° C. below the hot/wet glass transition temperature. Examples of commercially available cycloaliphatic epoxies with flexible aliphatic backbones are shown in Formulas A and B (where n can be, for example, an integer of from 1 to 5).

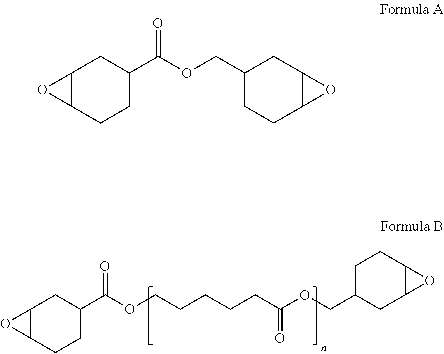

Including other low molecular weight cycloaliphatic epoxies with rigid backbones (such as the following dicyclopentadiene based epoxies; dicyclopentadiene diepoxide, bis norbornane epoxide, and tricyclopentadiene diepoxide) can improve the glass transition temperature of benzoxazine blends, as disclosed in International Pat. Pub. No. 2017188448A1. Unfortunately, if they are used in the same manner as described in the aforementioned publication there are several disadvantages that limit their use in benzoxazine resins. Firstly, in order to achieve high glass transition temperatures, these epoxies require the use of a curing agent, 4,4′-sulfonyldiphenol, that has a melting point around or above room temperature further increasing the viscosity of the resin composition. In addition, even when a curing agent is used these epoxies require curing temperatures as high as 260° C., which is above the degradation temperature of the benzoxazine resin in addition to being undesirable from a processing standpoint. When a lower curing temperature is used, for example 220° C., the glass transition temperature of the cured matrix is low because the benzoxazine resin has reacted but the cycloaliphatic epoxy has not due to the high reaction temperature, despite the presence of catalyst.

### SUMMARY OF THE INVENTION

To solve the aforementioned problem, the present inventors have discovered that incorporating a cycloaliphatic epoxy resin into a benzoxazine resin composition, wherein the cycloaliphatic epoxy resin has a particular type of structure (e.g., the cycloaliphatic epoxy resin contains cycloaliphatic epoxy moieties which are connected by a single bond or a linkage group having a molecular weight less than 45 g/mol or contains a fused ring system), and coordinating the peak reaction temperatures of the multifunctional benzoxazine resin and cycloaliphatic epoxy resin components achieves both a high glass transition temperature and modulus retention, especially after moisture conditioning, in the cured matrix and low viscosity (in the uncured state) at room temperature. The present invention therefore provides a benzoxazine resin composition that can be cured to form a cured product excellent in heat resistance, thereby overcoming the disadvantages of the resin compositions known in the prior art as described above.

This invention relates to a benzoxazine resin composition for a fiber-reinforced composite material, comprising, consisting essentially of or consisting of a component [A] having a peak reaction temperature and a component [B] having a peak reaction temperature, wherein:

a) the peak reaction temperatures of components [A] and component [B] as measured in the benzoxazine resin composition by differential scanning calorimetry (DSC) are within 50° C. of each other;

b) component [A] comprises, consists essentially of or consists of at least one multifunctional benzoxazine resin; and

c) component [B] comprises, consists essentially of or consists of at least one cycloaliphatic epoxy resin represented by Formula (I):

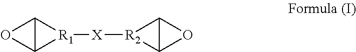

wherein R₁ and R₂ are the same or different and are each an aliphatic moiety which together with carbon atoms of an epoxy group form at least one aliphatic ring and X is optionally present, wherein when X is not present the cycloaliphatic epoxy resin comprises fused aliphatic rings involving R₁and R₂ and when X is present X represents a single bond or a divalent moiety having a molecular weight less than 45 g/mol; and

d) when the peak reaction temperatures of component [A] and component [B] as measured in the benzoxazine resin composition by DSC in the absence of a polymerization catalyst are not within 50° C. of each other, the benzoxazine resin composition additionally comprises, consists essentially of or consists of a component [D] comprised of, consisting essentially of or consisting of a polymerization catalyst which is effective to bring the peak reaction temperatures of component [A] and component [B] as measured by differential scanning calorimetry in the benzoxazine resin composition to within 50° C. of each other.

Thus, component [A] may comprise, consist essentially of or consist of one or more multifunctional benzoxazine resins and component [B] may comprise, consist essentially of or consist of one or more cycloaliphatic epoxy resins. A component [D] which may comprise, consist essentially of or consist of one or more polymerization catalysts may or may not be present in the benzoxazine resin composition, depending upon whether in the absence of polymerization catalyst component [A] and component [B] as formulated together exhibit peak reaction temperatures which are sufficiently close to each other for the purposes of this invention (e.g., within 50° C. of each other). The benzoxazine resin composition may, or may not, additionally contain one or more components other than components [A], [B] and [D].

In various embodiments of the invention, the peak reaction temperatures of component [A] and component [B] as measured by differential scanning calorimetry (in the formulated benzoxazine resin composition) are within 50° C. of each other, within 45° C. of each other, within 40° C. of each other, within 35° C. of each other, within 30° C. of each other, within 25° C. of each other, within 20° C. of each other, within 15° C. of each other, within 10° C. of each other or within 5° C. of each other. In other embodiments, the peak reaction temperatures of components [A] and [B] in the formulated benzoxazine resin composition are essentially the same or the same.

In preferred embodiments, the peak reaction temperature of component [A] is less than the peak reaction temperature of component [B] in the formulated benzoxazine resin composition. For example, the peak reaction temperature of component [A] may be less than, but no more than 50° C. less than, no more than 45° C. less than, no more than 35° C. less than, no more than 30° C. less than, no more than 25° C. less than, no more than 20° C. less than, no more than 15° C. less than, no more than 10° C. less than, or no more than 5° C. less than the peak reaction temperature of component [B]. Generally speaking, it has been found to be desirable to select and control the components of the benzoxazine resin composition of the present invention such that when the benzoxazine resin composition is heated, curing of both components takes place simultaneously during at least a portion of the heating cycle. That is, component [B] begins to react and cure when at least a portion of component [A] remains uncured.

The benzoxazine resin composition of the present invention is useful in the molding of fiber-reinforced composite materials. More particularly, the present invention makes it possible to provide a benzoxazine resin composition for a fiber-reinforced composite material where the cured material obtained by heating has a high level of heat resistance. In the field of this invention, a material having a high level of heat resistance is defined as a material having a high glass transition temperature and high mechanical properties at or close to that temperature.

For example, when the benzoxazine resin composition is cured to provide a cured matrix having a glass transition temperature, the glass transition temperature of the cured matrix may be at least 10° C. higher, at least 15° C. higher or at least 20° C. higher than the highest curing temperature as determined by the G′ onset method (described in more detail in the Examples).

In other embodiments, when the benzoxazine resin composition is cured at a temperature equal to or less than 220° C. to provide a cured matrix having a glass transition temperature, the glass transition temperature of the cured matrix after exposure to moisture (immersion in boiling deionized water for 24 hours), that is at least 205° C. as determined by the G′ onset method (described in more detail in the Examples).

According to still further embodiments, when the benzoxazine resin composition is cured to provide a cured matrix having a flexural modulus of elasticity, the flexural modulus of elasticity of the cured matrix at 180° C. after exposure to moisture (immersion in boiling deionized water for 24 hours) may be at least 30%, at least 35%, at least 40%, at least 50%, or at least 60% of the flexural modulus of elasticity of the cured matrix at room temperature (25° C.) under ambient conditions as determined by the three point bend method (ASTM D-790).

In one embodiment, component [A] may include at least one benzoxazine resin containing two or more structural units represented by Formula (II):

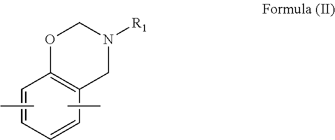

wherein R₁ denotes a linear alkyl group with a carbon number of 1 to 12, a cyclic alkyl group with a carbon number of 3 to 8, a phenyl group, or a phenyl group that is substituted with a linear alkyl group having a carbon number of 1 to 12 or a halogen, with a hydrogen being bonded to at least one of the carbon atoms at the ortho-position and the para-position with respect to a carbon atom to which an aromatic-ring oxygen atom is bonded.

In the structural unit represented by the general Formula (II) above, non-limiting examples of R₁ include a methyl group, ethyl group, propyl group, isopropyl group, n-butyl group, isobutyl group, t-butyl group, cyclopentyl group, cyclohexyl group, phenyl group, o-methylphenyl group, m-methylphenyl group, p-methylphenyl group, o-ethylphenyl group, m-ethylphenyl group, p-ethylphenyl group, o-t-butylphenyl group, m-t-butylphenyl group, p-t-butylphenyl group, o-chlorophenyl group, o-bromophenyl group, dicyclopentadiene group or benzofuranone group.

Among these groups, it is preferable for R₁ to be a methyl group, ethyl group, propyl group, phenyl group, or o-methylphenyl group, as the use of such a benzoxazine resin contributes to favorable handling properties.

In another embodiment, component [B] includes at least one cycloaliphatic epoxy resin represented by Formula (I),

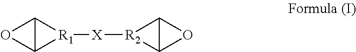

wherein R₁and R₂ are the same or different and are each an aliphatic moiety which together with carbon atoms of an epoxy group form at least one aliphatic ring and X represents a single bond or a divalent moiety having a molecular weight less than 45 g/mol. R₁ and R₂ can each, for example, independently comprise three carbon chains or four carbon chains, thereby forming five-membered or six-membered aliphatic rings respectively. R₁ and/or R₂ can also have structures which provide bicyclic rings, such as a norbornane ring. In other embodiments, X is not present in the cycloaliphatic epoxy resin of Formula (I) and fused aliphatic rings are present which include R₁ and R₂ (that is, a fused ring system is present which involves R₁ and R₂).

In another embodiment of the invention, the equivalent ratio [A_{eq}]/[B_{eq}] of the benzoxazine functional groups of [A] and the epoxy groups of [B] is 0.5 to 2.5. That is, component [A] and component [B] are present in the benzoxazine resin composition in amounts effective to provide an equivalent ratio of [A_{eq}]/[B_{eq}] of 0.5 to 2.5, where [A_{eq}]=equivalents of benzoxazine functional groups in component [A] and [B_{eq}]=equivalents of epoxy groups in component [B].

In another embodiment of the invention, the benzoxazine resin composition may additionally be comprised of, consist essentially of or consist of component [C], wherein the component [C] comprises at least one thermoplastic compound, such as a polyethersulfone, polyimide, amine-functional butadiene copolymer, carboxyl-terminated butadiene or butadiene-acrylonitrile copolymer. In the case of a polyimide thermoplastic compound, the thermoplastic compound's backbone may additionally contain phenyltrimethylindane or phenylindane units.

In another embodiment of the invention, the benzoxazine resin composition may additionally be comprised of component [D], wherein the component [D] comprises at least one polymerization catalyst, such as a sulfonate ester (e.g., an alkyl ester of an aryl sulfonic acid, such as ethyl p-toluenesulfonate). As used herein, the term “polymerization catalyst” means a substance capable of catalyzing the reaction (curing) of one or both of components [A] and [B]. At least one polymerization catalyst is present in the benzoxazine resin composition when the peak reaction temperatures of component [A] and component [B] as combined in the benzoxazine resin composition would otherwise (i.e., in the absence of polymerization catalyst) be greater than 50° C. apart from each other. At least one polymerization catalyst may optionally be present in the benzoxazine resin composition when the peak reaction temperatures of component [A] and component [B] in the benzoxazine resin composition would otherwise (i.e., in the absence of polymerization catalyst) be within 50° C. of each other.

In another embodiment of the invention, the benzoxazine resin composition may additionally be comprised of component [E], wherein the component [E] comprises thermoplastic resin particles with an average particle diameter of preferably 5 to 30 μm.

Also provided by the present invention are prepregs comprised of carbon fibers impregnated with a benzoxazine resin composition in accordance with any of the above-mentioned embodiments as well as a carbon fiber-reinforced composite material obtained by curing such a prepreg or a laminate body formed from a plurality of such prepregs. Further embodiments of the invention provide a carbon fiber-reinforced composite material comprising a cured resin product obtained by curing a mixture comprised of a benzoxazine resin composition in accordance with any of the above-mentioned embodiments and carbon fibers.

An additional embodiment of the invention provides a method of making a benzoxazine resin composition, wherein the method comprises:
a) selecting a component [A] having a peak reaction temperature as measured by differential scanning calorimetry and comprising, consisting essentially of or consisting of at least one multifunctional benzoxazine resin;
b) selecting a component [B] having a peak reaction temperature as measured by differential scanning calorimetry and comprising, consisting essentially of or consisting of at least one cycloaliphatic epoxy resin represented by Formula (I):

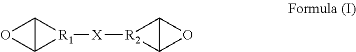

wherein R₁ and R₂ are the same or different and are each an aliphatic moiety which together with carbon atoms of an epoxy group form at least one aliphatic ring and X is optionally present, wherein when X is present X represents a single bond or a divalent moiety having a molecular weight less than 45 g/mol and when X is not present the cycloaliphatic epoxy resin comprises fused aliphatic rings involving R₁ and R₂; and
c) combining at least component [A] and component [B] to obtain the benzoxazine resin composition;
wherein a component [D] comprised of a polymerization catalyst which is effective to bring the peak reaction temperatures of component [A] and component [B] to within 50° C. of each other is additionally combined with component [A] and component [B] if the peak reaction temperatures of component [A] and component [B] in the benzoxazine resin composition as measured by differential scanning calorimetry are not within 50° C. of each other in the absence of the polymerization catalyst.

### DETAILED DESCRIPTION OF EMBODIMENTS OF THE INVENTION

All publications, patents, and patent applications cited in this specification are hereby incorporated by reference in their entirety for all purposes.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this specification are used to describe and account for small fluctuations. For example, they can refer to amounts or quantities that differ from a stated value by less than or equal to ±5%.

Reference throughout this specification to “one embodiment” or “an embodiment” means that a particular feature, structure, or characteristic described in, connection with the embodiment is included in at least one embodiment. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

Unless otherwise specified, “room temperature” as used herein refers to a temperature of 25° C. In accordance with the present disclosure, a benzoxazine resin composition can be obtained that has superior heat resistance (when cured) and superior processability as well as mechanical properties in regard to modulus when cured. Moreover, by using the benzoxazine resin composition of the present disclosure, a fiber-reinforced composite material with an excellent modulus and glass transition temperature can be obtained by curing this benzoxazine resin composition and such fiber-reinforced composite material manifests superior mechanical properties when used in combination with reinforcing fiber.

The benzoxazine resin composition, the prepreg, and the fiber-reinforced composite material of the present disclosure are described in detail below.

As a result of extensive research in view of the difficulties described above, the inventors have discovered that the aforementioned problems are resolved by employing, in fiber-reinforced composite material applications, a benzoxazine resin composition formed by mixing at least one multifunctional benzoxazine resin [A] and at least one epoxy resin [B] having certain structural features.

In the present invention, a multifunctional benzoxazine resin means a benzoxazine compound having at least two oxazine rings attached to benzene rings within the molecule, that is to say one which is at least difunctional. Difunctional and trifunctional benzoxazine resins and combinations thereof are particularly useful in the present invention. Such benzoxazine resins are well known in the art and are also available from a variety of commercial sources.

According to certain embodiments, component [A] comprises, consists essentially of or consists of at least one multifunctional benzoxazine resin containing two or more structural units as represented by general Formula (II) below.

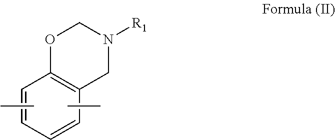

In Formula (II), R₁ denotes a linear alkyl group with a carbon number of 1 to 12, a cyclic alkyl group with a carbon number of 3 to 8, a phenyl group, or a phenyl group that is substituted with a linear alkyl group having a carbon number of 1 to 12 or a halogen, with a hydrogen being bonded to at least one of the carbon atoms at the ortho-position and the para-position with respect to a carbon atom to which an aromatic-ring oxygen atom is bonded.

In the structural unit represented by the general Formula (II) above, non-limiting examples of R₁ include a methyl group, ethyl group, propyl group, isopropyl group, n-butyl group, isobutyl group, t-butyl group, cyclopentyl group, cyclohexyl group, phenyl group, o-methylphenyl group, m-methylphenyl group, p-methylphenyl group, o-ethylphenyl group, m-ethylphenyl group, p-ethylphenyl group, o-t-butylphenyl group, m-t-butylphenyl group, p-t-butylphenyl group, o-chlorophenyl group, o-bromophenyl group, dicyclopentadiene group or benzofuranone group. Among these groups, it is preferable to use a methyl group, ethyl group, propyl group, phenyl group, or o-methylphenyl group, as the presence of such groups contributes to favorable handling properties.

The structural units represented by structural Formula (II) may be linked directly (e.g., by a single bond connecting benzene rings) or through a linker group, especially a divalent linker group such as —CH₂—, —C(CH₃)₂—, carbonyl, —S—, —SO₂—, —O—, or —CH(CH₃)—. Such divalent linker groups may bond to a carbon atom in the benzene ring of one structural unit of Formula (II) and to a carbon atom in the benzene ring of another structural unit of Formula (II). It is also possible for the structural units of structural Formula (II) to be linked through the nitrogen atoms of such structural units (involving the R₁ substituents) by means of a divalent linker group, corresponding to the general formula N-L-N where L is a divalent linker group and each N is part of an oxazine ring. For example, such a linker group may be —Ar—CH₂—Ar—, wherein Ar is a benzene ring (as illustrated in structural Formula (IIB) and Formula (XIV) below). Other suitable linker groups include —Ar—, —Ar—S—Ar—, and —Ar—O—Ar—, where Ar is a benzene ring.

Further difunctional benzoxazine resins suitable for use in the present invention include, for example, those represented by the following Formula (IIA) and Formula (IIB):

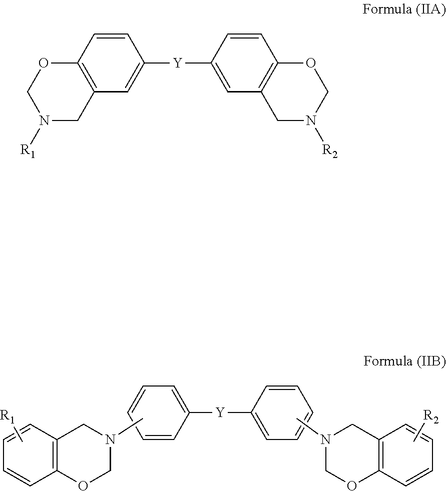

Y is selected from a direct bond, —C(R³)(R⁴)—, —C(R³)(aryl)—, —C(═O)—, —S—, —O—, —S(═O)—, —S(═O)₂—, a divalent heterocycle (e.g., 3,3-isobenzofuran-1(3h)-one) and —[C(R₃)(R₄)]-arylene-[C(R₅)(R₆)]_{y}—, or the two benzyl rings of the benzoxazine moieties may be fused.

R₁ and R₂ in Formula (IIA) are independently selected from alkyl (e.g., C₁₋₈ g alkyl), cycloalkyl (e.g., C₅₋₇ cycloalkyl, preferably C₆ cycloalkyl) and aryl, wherein the cycloalkyl and aryl groups are optionally substituted, for instance by C₁₋₈ alkyl, halogen and amine groups, and, where substituted, one or more substituent groups (preferably one substituent group) may be present on each cycloalkyl and aryl group. R₁ and R₂ in Formula (IIB) may be independently selected from the same groups, but additionally may be hydrogen.

R₃, R₄, R₅, and R₆ are independently selected from H, C₁₋₈ alkyl (preferably C₁₋₄ alkyl, and preferably methyl), and halogenated alkyl (wherein the halogen is typically chlorine or fluorine); and x and y are independently 0 or 1. Where an arylene group is present, the arylene group is preferably phenylene. In one embodiment, the groups attached to the phenylene group may be configured in para- or meta-positions relative to each other. Where an aryl group is present, the aryl group is preferably phenyl.

The group Y may be linear or non-linear, and is typically linear. The group Y is preferably bound to the benzyl group of each of the benzoxazine moieties at the para-position relative to the oxygen atom of the benzoxazine moieties, as shown in Formula (IIA), and this is the preferred isomeric configuration. However, the group Y may also be attached at either of the meta-positions or the ortho-position, in one or both of the benzyl group(s) in the difunctional benzoxazine compound. Thus, the group Y may be attached to the benzyl rings in a para/para; para/meta; para/ortho, meta/meta or ortho/meta configuration.

In another embodiment, the difunctional benzoxazine resin corresponding to Formula (IIA) is selected from compounds wherein R₁ and R₂ are independently selected from aryl, preferably phenyl. In one embodiment, the aryl group may be substituted, preferably wherein the substituent(s) are selected from C₁₋₈ alkyl, and preferably wherein there is a single substituent present on at least one aryl group. C₁₋₈ alkyl includes linear and branched alkyl chains. Preferably, R₁ and R₂ in Formula (IIA) are independently selected from unsubstituted aryl, preferably unsubstituted phenyl.

The benzyl ring in each benzoxazine group of the difunctional benzoxazine resins defined herein as Formula (IIA) may be independently substituted at any of the three available positions of each ring, and typically any optional substituent is present at the position ortho to the position of attachment of the Y group. Preferably, however, the benzyl ring remains unsubstituted.

Suitable trifunctional benzoxazine resins include compounds that may be prepared by reacting aromatic triamines with phenols (monohydric or polyhydric) in the presence of aldehyde such as formaldehyde or a source or equivalent thereof.

In the present disclosure, it is preferable to use at least one monomer represented by the structural Formulas (III) to (XIV) below as the multifunctional benzoxazine resin of component [A].

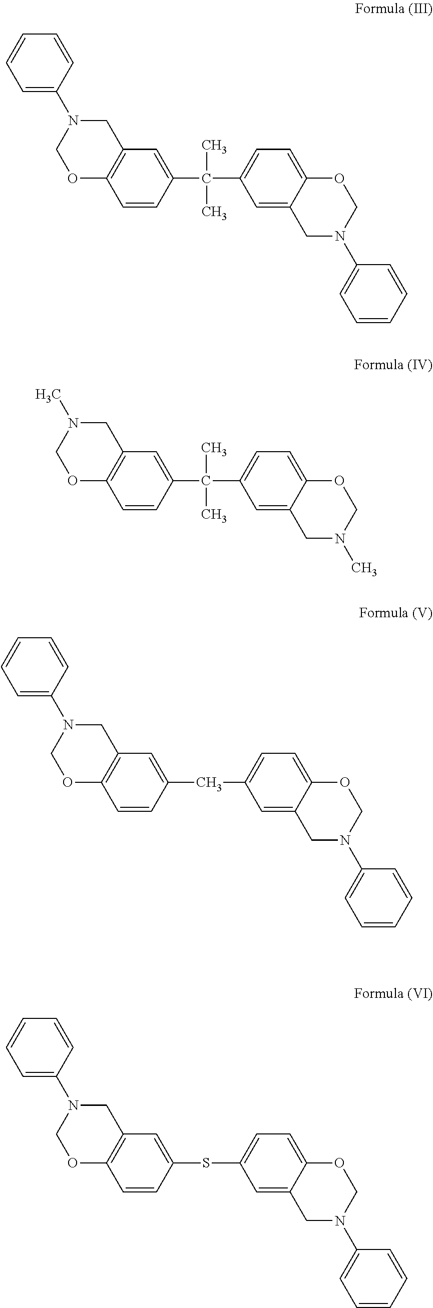

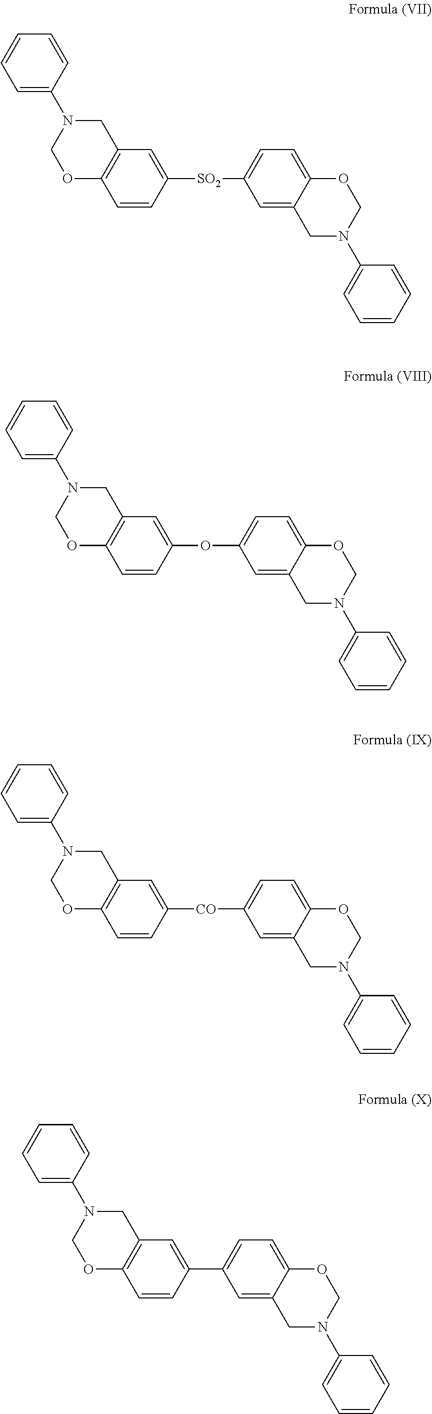

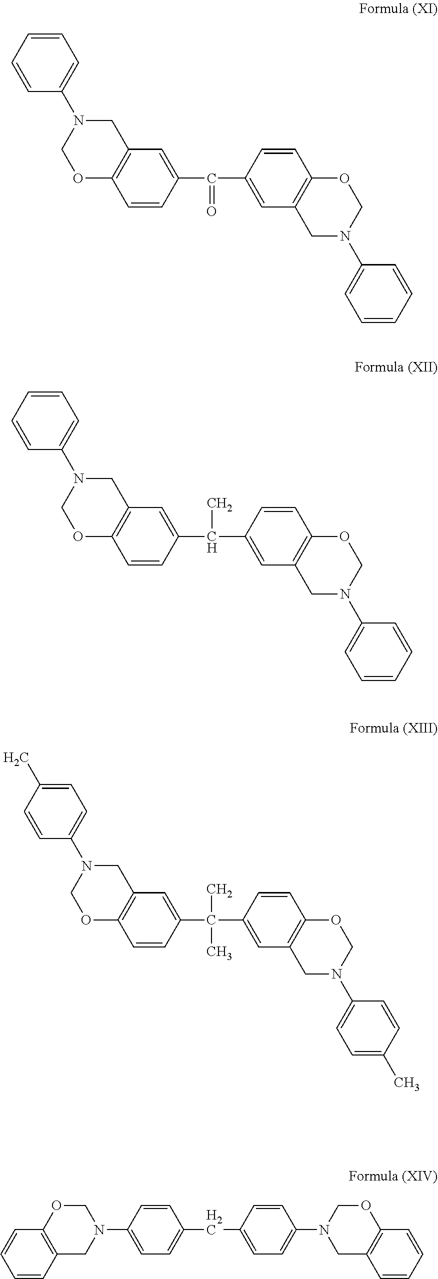 [SMILES: O=C(c1ccc2c(c1)CN(c1ccccc1)CO2)c1ccc2c(c1)CN(c1ccccc1)CO2 ; CC(c1ccc2c(c1)CN(c1ccccc1)CO2)c1ccc2c(c1)CN(c1ccccc1)CO2 ; Cc1ccc(N2COc3ccc(C(C)(C)c4ccc5c(c4)CN(c4ccc(C)cc4)CO5)cc3C2)cc1 ; c1ccc2c(c1)CN(c1ccc(Cc3ccc(N4COc5ccccc5C4)cc3)cc1)CO2]

In certain embodiments of the present invention, component [A] preferably comprises (or consists essentially of or consists of) at least one multifunctional benzoxazine resin and may be composed of monomer alone or may have the form of an oligomer in which multiple molecules are polymerized. In addition, multifunctional benzoxazine resins having different structures may be used together (i.e., component [A] may contain two or more multifunctional benzoxazine resins, which may be designated as [A1], [A2], etc.).

The multifunctional benzoxazine resin(s) used as component [A] may be procured from a number of suppliers, including Shikoku Chemicals Corp., Konishi Chemical Inc., Co., Ltd., and Huntsman Advanced Materials. Among these suppliers, Shikoku Chemicals Corp. offers a bisphenol A-aniline type benzoxazine resin, a bisphenol A methylamine type benzoxazine resin, and a bisphenol F aniline type benzoxazine resin. Rather than using commercially-available raw material, the multifunctional benzoxazine resin can be prepared, as necessary, by allowing a reaction to occur between a phenolic compound (e.g., bisphenol A, bisphenol F, bisphenol S, or thiodiphenol), an aldehyde and an arylamine. Detailed preparation methods may be found in U.S. Pat. Nos. 5,543,516, 4,607,091 (Schreiber), U.S. Pat. No. 5,021,484 (Schreiber), and U.S. Pat. No. 5,200,452 (Schreiber).

In the present invention, an epoxy resin means an epoxy compound having at least two 1,2-epoxy groups within the molecule, that is to say an epoxy compound which is at least difunctional with respect to epoxy functional groups.

In certain embodiments of the present invention, component [B] contains at least one cycloaliphatic epoxy resin represented by Formula (I), wherein R₁ and R₂ are the same or different and are each an aliphatic moiety which together with carbon atoms of an epoxy group form at least one aliphatic ring (in certain cases, a bicyclic aliphatic ring is formed) and X represents a single bond or a divalent moiety having a molecular weight less than 45 g/mol. In other embodiments, X is not present in Formula (I) and the cycloaliphatic epoxy resin comprises a fused ring system involving R₁ and R₂, such as in dicyclopentadiene diepoxide.

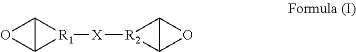

Here, a cycloaliphatic epoxy resin means an epoxy resin in which there is at least two 1,2-epoxycycloalkane structural moieties (wherein each such moiety is an aliphatic ring in which two adjacent carbon atoms which are part of the aliphatic ring also are part of an epoxy ring, each being bonded to the same oxygen atom). As previously stated, cycloaliphatic epoxy resins are useful because they can reduce the viscosity of the resin composition. However, typical cycloaliphatic epoxies, such as 3,4-epoxycyclohexylmethyl-3,4-epoxycyclohexanecarboxylate, can also reduce the glass transition temperature and modulus of the cured material. To solve this problem, cycloaliphatic epoxies with shorter, more rigid, linkages between 1,2-epoxycycloalkane groups or containing fused ring systems are employed in the present invention.

Examples of shorter, more rigid, linkages between 1,2-epoxycycloalkane groups, wherein the divalent moiety has a molecular weight less than 45 g/mol, are oxygen (X=—O—), sulfur (X=—S—), alkylene (e.g., X=—CH₂—, —CH₂CH₂—, —CH₂CH₂CH₂—, —CH₂CH(CH₃)— or —C(CH₃)₂—), an ether-containing moiety (e.g., X=—CH₂OCH₂—), a carbonyl-containing moiety (e.g., X=—C(═O)—), or an oxirane ring-containing moiety (e.g., X=—CH—O—CH—, wherein a single bond exists between the two carbon atoms thereby forming a three-membered ring including the oxygen atom and the two carbon atoms).

In certain embodiments, X in Formula (I) is not present, meaning that R₁ and R₂ are part of a fused ring system. Dicyclopentadiene diepoxide is an example of a cycloaliphatic epoxy resin in which R₁ and R₂ are part of a fused ring system. In other embodiments, X in Formula (I) is a single bond which connects cyclic groups containing R₁ and R₂.

The cycloalkane groups present in such cycloaliphatic epoxy resins may, for example, be monocyclic or bicyclic (e.g., a norbornane group). Examples of suitable monocyclic cycloalkane groups include, but are not limited to, cyclohexane groups and cyclopentane groups. Such cycloalkane groups may be substituted (for example, with alkyl groups) or, preferably, unsubstituted. Where X is a single bond or a divalent moiety having a molecular weight less than 45 g/mol, the epoxy groups on such cyclohexane and cyclopentane rings may be present at the 2,3 or 3,4 positions on the rings.

Employing a cycloaliphatic epoxy with an aforementioned single bond, a divalent moiety having a molecular weight less than 45 g/mol, or a fused ring system is advantageous, as the molecule's rigidity increases the modulus of the cured material. Furthermore, including a divalent moiety that meets the previously mentioned criteria but is also capable of forming a covalent bond with other components of the resin formulation (for example, where X is an oxirane ring-containing moiety) is advantageous since increasing the crosslink density can improve both the glass transition temperature and modulus of the cured material.

Specific illustrative examples of cycloaliphatic epoxy resins useful as component [B] are bis(3,4-epoxycyclohexyl) (where Y is a single bond, also referred to as 3,4,3′,4′-diepoxybicyclohexyl); bis[(3,4-epoxycyclohexyl)ether] (where Y is an oxygen atom), bis[(3,4-epoxycyclohexyl)oxirane] (where Y is an oxirane ring, —CH—O—CH—), bis[(3,4-epoxycyclohexyl)methane] (where Y is methylene, CH₂), 2,2-bis(3,4-epoxycyclohexyl)propane (where Y is —C(CH₃)₂—) and the like and combinations thereof. In addition, mono and bi cyclopentane substituted versions of the aforementioned monomers including bis(3,4-epoxycyclopentyl), bis(3,4-epoxycyclopentyl) ether and 3,4-epoxycyclopentyl-3,4-epoxycyclohexyl, may be employed.

Examples of cycloaliphatic epoxy resins where X is nonexistent (i.e., is not present) and R₁ and R₂ are part of a fused ring system include dicyclopentadiene diepoxide and tricyclopentadiene diepoxide.

Illustrative examples of suitable cycloaliphatic epoxy resins include the following compounds represented by the structural Formulas (XV) to (XIX) below as the epoxy resin of component [B].

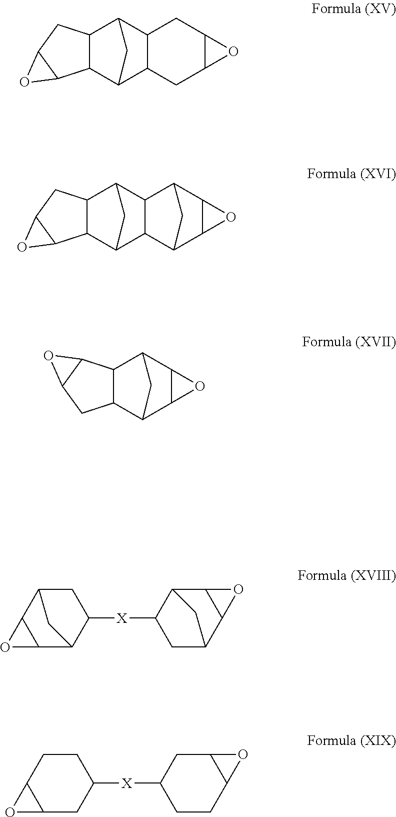

In Formula (XIX), X=a single bond, —O—,—S—, —CH₂—, —CH₂CH₂—, —CH₂CH₂CH₂—, —CH₂CH(CH₃)—, —C(CH₃)₂—, —CH₂OCH₂—, —C(═O)—, or oxirane; one or both of the cyclohexane rings may be replaced by a cyclopentane ring and/or a norbornane ring.

Formula (XVIII) shown above is an example of a cycloaliphatic epoxy resin in which X in Formula (I) represents a single bond and R₁ and R₂ are aliphatic moieties which are part of bicyclic aliphatic rings.

Formulas (XV), (XVI) and (XVII) are examples of cycloaliphatic epoxy resins in which X is not present and the cycloaliphatic epoxy resin contains fused aliphatic rings (these compounds also contain bicyclic aliphatic rings).

Such cycloaliphatic epoxy resins are known in the art and may be prepared using any suitable synthetic method, including, for example, by epoxidizing cycloaliphatic di- and triolefinic compounds such as compounds having a 3,3′-dicyclohexenyl skeleton. U.S. Pat. No. 7,732,627 and U.S. Pat. Pub. Nos. 2004/0242839 and 2014/0357836, for instance, describe methods for obtaining cycloaliphatic epoxy resins useful in the present invention.

Component [B] may contain more than one cycloaliphatic epoxy resin, wherein the different cycloaliphatic epoxy resins may be designated as [B1], [B2], [B3], etc.

In one embodiment, the ratio of benzoxazine functional groups provided by component [A] to epoxide functional groups provided by component [B] is in the range of 0.5 to 2.5. Within this range, benzoxazine resin compositions having viscosity ranges that are more suitable for manufacturing processes are obtained, while also producing suitable pressure-sensitive adhesion (tackiness) and deformability (draping properties) in prepregs. In addition, because excellent modulus and glass transition temperature are maintained in the cured benzoxazine resin composition, the material will provide superior mechanical characteristics at elevated temperatures, especially in hot and wet environments when used as a composite material. If the blend amount of the [B] component relative to the [A] component is too small, then the viscosity of the benzoxazine resin composition will increase, which may compromise manufacture processability, viscosity (tackiness) and deformability (draping properties) during prepreg formation. If the blend amount of the [B] component is too great, however, then the characteristics of low moisture absorption and high modulus which are attributable to the benzoxazine compound will be lost. As a result, the mechanical properties when used as a composite material in hot, moist environments will tend to be compromised.

In certain embodiments of the present invention, the benzoxazine resin composition may additionally comprise an aromatic glycidyl ether type epoxy resin (such as a bisphenol A epoxy resin) and/or at least one aromatic glycidyl amine type epoxy resin (e.g., epoxy resins prepared by reacting aromatic amines with epichlorohydrin). Including these types of epoxies in the resin composition can improve the solubility of the thermoplastic compound in the benzoxazine resin composition.

In certain embodiments of the present invention, the benzoxazine resin composition may additionally comprise a mono-functional benzoxazine resin. Including this type of benzoxazine in the resin composition can improve the solubility of the thermoplastic compounds and lower the viscosity of the benzoxazine resin composition. Mono-functional benzoxazine resins are compounds which contain a single benzoxazine unit per molecule; such compounds are well-known in the art and can be prepared by reacting monohydric phenols, monofunctional amines, and aldehydes such as paraformaldehyde.

In certain embodiments of the present invention, mixing or dissolving at least one thermoplastic compound, component [C], into the above-mentioned benzoxazine resin composition may also be desirable to enhance the properties of the cured material. In general, a thermoplastic compound (polymer) having bonds selected from the group consisting of carbon-carbon bonds, amide bonds, imide bonds, ester bonds, ether bonds, carbonate bonds, urethane bonds, thioether bonds, sulfone bonds and/or carbonyl bonds in the main chain of the thermoplastic compound (polymer) is preferred. Further, the thermoplastic compound can also have a partially crosslinked structure and may be crystalline or amorphous. In particular, it is suitable or preferred that at least one thermoplastic compound selected from the group consisting of polyamides, polycarbonates, polyacetals, polyphenylene oxides, polyphenylene sulfides, polyallylates, polyesters, polyamideimides, polyimides (including polyimides having a phenyltrimethylindane or phenylindane structure), polyetherimides, polysulfones, polyethersulfones, polyetherketones, polyetheretherketones, polyaramids, polyethernitriles and polybenzimidazoles is mixed or dissolved into the benzoxazine resin composition.

In certain embodiments of the present invention, the glass transition temperature (Tg) of component [C] is 150° C. or greater so that favorable heat resistance is obtained, with 170° C. or greater being preferred. The glass transition temperature may be measured by differential scanning calorimetry, following the procedures described in detail in the Examples. If the glass transition temperature of the component [C] that is blended is less than 150° C., the resulting moldings will tend to suffer thermal deformation during use. From the standpoint of producing high heat resistance or high solvent resistance, or from the standpoint of affinity with respect to the benzoxazine resin composition, including solubility and adhesion, it is preferable to use a polysulfone, polyethersulfone, polyphenylene sulfide, polyimide (including polyimides having a phenyltrimethylindane or phenylindane structure), or polyetherimide.

Specific examples of suitable sulfone-based thermoplastic compounds are polyethersulfones and the polyethersulfone-polyetherethersulfone copolymer oligomers as described in US 2004/044141 A1. Specific examples of suitable imide-based thermoplastic compounds are polyimides and the polyimide- phenyltrimethylindane oligomers as described in U.S. Pat. No. 3,856,752.

An oligomer refers to a polymer with a relatively low molecular weight in which a finite number of approximately ten to approximately 100 monomer molecules are bonded to each other.

Although the benzoxazine resin composition need not contain a thermoplastic compound, in various embodiments of the invention the benzoxazine resin composition is comprised of at least 5 or at least 10 parts by weight thermoplastic compound per 100 parts by weight in total of components [A] and [B]. For example, the benzoxazine resin composition may be comprised of from 10 to 30 parts by weight thermoplastic compound per 100 parts by weight in total of components [A] and [B].

In certain embodiments of the present invention, mixing or dissolving a polymerization catalyst [D] into the above-mentioned benzoxazine resin composition may also be desirable to decrease the curing temperature and time, and to achieve optimum mechanical properties such as modulus and glass transition temperature. A polymerization catalyst may also be used to desirably bring the peak reaction temperatures of component [A] and component [B] as observed in combination in the benzoxazine resin composition closer to each other than they would be in the absence of the polymerization catalyst. The polymerization catalyst [D] may promote the ring-opening polymerization of the multifunctional benzoxazine resin [A], the cycloaliphatic epoxy resin [B], or both during the cure of the benzoxazine resin composition. Such ring-opening polymerization may proceed by way of a cationic or anionic polymerization mechanism, for example. Generally, polymerization catalysts for cationic polymerization systems include Lewis acids and Bronsted acids, metal halides, and organometallic reagents. Examples of polymerization catalysts for anionic polymerization systems include imidazole derivatives, tertiary amines, and phosphines.

Polymerization catalysts may be used independently or in combination with one or more other catalysts.

In certain embodiments of the present invention, it is preferable to use one or more Lewis acid complexes or Bronsted acid salts as the polymerization catalyst [D]. These are suitable polymerization catalysts for the benzoxazine resin composition of the present disclosure because they provide superior stability at room temperature (25° C.) and in prepreg production processes (typically carried out at temperatures of about 50° C. to about 90° C.), and facilitate adjustment of the reaction initiation temperature.

Examples of Lewis acid complexes and Bronsted acid salts include protic acid esters, halogenated boron complexes, aromatic sulfonium salts, aromatic diazonium salts, aromatic pyridinium salts, and aromatic iodonium salts. Among these compounds, using at least one selected from the group consisting of protic acid esters, halogenated boron complexes, and aromatic sulfonium salts provides the benzoxazine resin composition with superior stability at room temperature or during prepreg production processes. From the standpoint of stability at room temperature, the protic acid esters which are aromatic sulfonate esters such as toluenesulfonate esters and benzenesulfonate esters are preferred, because these catalysts are in an esterified state at room temperature and thus have poor reaction promoting effects at low temperatures.

The [D] component in certain embodiments of the present invention is a sulfonate ester which promotes the ring-opening reaction of the benzoxazine rings of the benzoxazine resin present in component [A] as well as the reaction between the epoxy resin component [B] and the phenolic hydroxyl groups of the benzoxazine component [A] that are present subsequent to ring-opening of benzoxazine structural units. By including component [D], curing of the benzoxazine resin composition of the embodiments herein can occur at a lower temperature in comparison to conventional compositions.

Although the benzoxazine resin composition need not contain a polymerization catalyst, in various embodiments of the invention the polymerization catalyst (e.g., sulfonate ester) [D] is used at 0.5 to 5 parts by weight with respect to 100 parts by weight of the entire benzoxazine resin composition. Within this range, there will typically be reaction promoting effects in the benzoxazine resin composition at 175 to 310° C., superior storage stability at room temperature (25° C.), as well as superior viscosity stability (pot life) during prepreg production processes. In addition, there will generally be no adverse effects on resin characteristics of the benzoxazine resin composition when cured, such as glass transition temperature. In another embodiment, the blend amount of component [D] may be suitably adjusted in consideration of the reactivity of component [B], and 0.5 to 2 parts by weight of [D] may be blended with respect to 100 parts by weight of the entire benzoxazine resin composition when the reactivity of component [B] is high, whereas 2 to 5 parts by weight of [D] may be blended with respect to 100 parts by weight of the entire benzoxazine resin composition when the reactivity of the component [B] is low. The amount and type of polymerization catalyst [D] may be selected so as to bring the peak reaction temperatures, or one of the peak reaction temperatures, of components [A] and [B] desirably closer to each other (e.g., to within 50° C. of each other).

Examples of aromatic diazonium salts include Americure® aromatic diazonium salts (American Can Co.) and Ultraset® aromatic diazonium salts (Adeka Corp.). In addition, examples of iodonium salts include diphenyliodonium hexafluoroarsinate, bis(4-chlorophenyl)iodonium hexafluoroarsinate, bis(4-bromophenyl)iodonium hexafluoroarsinate, phenyl(4-methoxyphenyl)iodonium hexafluoroarsinate, UV-9310C iodonium salt (Toshiba Silicone), Photoinitiator 2074 iodonium salt (Rhône-Poulenc), UVE series products (General Electric Corp.), and FC series products (3M). Examples of aromatic iodonium salts include Rhodorsil® P12074 (Rhodia Co.).

Examples of aromatic pyridinium salts include N-benzyl-4-benzoylpyridinium hexafluoroantimonate, N-cinnamyl-2-cyanopyridinium hexafluoroantimonate, and N-(3-methyl-2-butenyl)-2-cyanopyridinium hexafluorophosphate, which are described in JP-04-327574-A, JP-05-222122-A, and JP-05-262813-A.

Examples of aromatic sulfonium salts include the antimony hexafluoride system sulfonium salt SAN-AID® SI-L85, SAN-AID® SI-L145, SAN-AID® SI-L160, SAN-AID® SI-H15, SAN-AID® SI-H20, SAN-AID® SI-H25, SAN-AID® SI-H40, SAN-AID® SI-H50, SAN-AID® SI-60L, SAN-AID® SI-80L, SAN-AID® SI-100L, SAN-AID® SI-80, SAN-AID® SI-100, and SAN-AID® 51-150 (Sanshin Chemical Industry KK.), and the phosphorus hexafluoride system sulfonium salts SAN-AID® SI-110, SAN-AID⁶S1-110L and SAN-AID® SI-180L (Sanshin Chemical Industry KK).

Examples of halogenated boron complexes include boron trifluoride-piperidine complex, boron trifluoride-monoethylamine complex, boron trifluoride-triethanolamine complex (all Stella Chemifa Corp.), and boron trichloride-octylamine complex (Huntsman Advanced Materials).

Examples of commercially-available toluenesulfonate ester products suitable for use in component (D) include methyl p-toluenesulfonate, ethyl p-toluenesulfonate, n-propyl p-toluenesulfonate, cyclohexyl p-toluenesulfonate, 1,3-propanediyl di-p-toluenesulfonate, 2,2-dimethyl-1,3-propanediol bis(toluenesulfonate), and 4,(4-((phenylsulfonyl)oxy)phenoxy)phenyl p-toluenesulfonate. In addition, examples of suitable commercially-available benzenesulfonate ester products for component [D] include methyl benzenesulfonate, ethyl benzenesulfonate, n-propyl benzenesulfonate, cyclohexyl benzenesulfonate, 1,3-propanediyl dibenzenesulfonate, 2,2-dimethyl-1,3-propanediol bis(benzenesulfonate), and 4-(4-((phenylsulfonyl)oxy)phenoxy)phenyl benzenesulfonate. These toluenesulfonate esters and benzenesulfonate esters may be procured from reagent manufacturers such as Sigma-Aldrich Co. or Tokyo Chemical Industry Co., Ltd.

In certain embodiments of the invention, however, the benzoxazine resin composition does not contain a polymerization catalyst as part of a component [D]. For example, it is not necessary to include a polymerization catalyst when the peak reaction temperatures of components [A] and [B] as measured by DSC in the benzoxazine resin composition are sufficiently close enough to each other (e.g., within 50° C. of each other). It should be noted that under certain circumstances one of component [A] or component [B] can in effect act as a catalyst for polymerization of the other component. For instance, when component [A] reacts first, certain of the reaction products thereby generated may catalyze the polymerization of component [B], thereby lowering the peak reaction temperature of component [B] as compared to what would be observed if component [B] were to be heated in the absence of component [A].

To determine whether a polymerization catalyst may need to be included in a benzoxazine resin composition for the purpose of bringing the peak reaction temperatures of components [A] and [B] to within 50° C. of each other, the other desired components of the benzoxazine resin composition may be combined and the resulting composition subjected to differential scanning calorimetry analysis in accordance with the procedures described elsewhere herein. If such DSC analysis shows the peak reaction temperatures of components [A] and [B] are separated by more than 50° C., then one or more suitable polymerization catalysts as component [D] are formulated into the benzoxazine resin composition. Of course, even if the peak reaction temperatures of components [A] and [B] are determined to be within 50° C. of each other in the absence of polymerization catalyst, a polymerization catalyst may nonetheless optionally be included in the benzoxazine resin composition for the purpose of tailoring the curing characteristics of the composition to meet desired objectives (such as the properties of the cured matrix obtained from the composition). In certain embodiments of the invention it may also be beneficial to include thermoplastic resin particles as component [E]. Non-limiting examples of thermoplastic resins to be used in the form of particles according to the present invention are the thermoplastic resins having in their main chain a bond chosen from carbon-carbon bonds, amide bonds, imide bonds, ester bonds, ether bonds, carbonate bonds, urethane bonds, urea bonds, thioether bonds, sulfone bonds, imidazone bonds and carbonyl bonds. Specifically, there may be cited vinylic resins represented by polyacrylate, poly(vinyl acetate) and polystyrol, thermoplastic resins belonging to the engineering plastics such as polyamide, polyaramid, polyester, polyacetal, polycarbonate, poly(phenylene oxide), poly(phenylene sulfide), polyallylate, polybenzimidazole, polyimide, polyamideimide, polyetherimide, polysulfone, polyethersulfone and polyetheretherketone, hydrocarbon resins represented by polyethylene and polypropylene and cellulose derivatives such as cellulose acetate and cellulose lactate.

Particularly, polyamide, polycarbonate, polyacetal, poly(phenylene oxide), poly(phenylene sulfide), polyallylate, polyester, polyamideimide, polysulfone, polyethersulfone, polyetheretherketone, polyaramid and polybenzimidazole are distinguished in impact resistance and are suitable as a material for the thermoplastic resin particles used according to certain embodiments of the present invention. Of these, polyamide, polyethersulfone and polysulfone are highly tenacious and heat resistant and are preferable for the present invention. The tenacity of polyamide is particularly distinguished, and by using particles of a polyamide such as non-crystalline transparent nylon, heat resistance is provided concurrently.

The quantity of the component [E] is preferably within the range of 0 to 100 parts by weight to 100 parts by weight in total of components [A] and [B]. When it is over 100 parts by weight, blending with components [A] and [B] becomes difficult; further, the tackiness and draping properties of the prepreg are greatly reduced. In order to retain the rigidity of the cured benzoxazine resin composition for development of the compressive strength of the composite material, improve the interlaminar fracture toughness of the composite material with thermoplastic resin particles and maintain the characteristics of high rupture elongation and flexibility, a smaller quantity of the thermoplastic resin particles within the range of 1 to 30 parts by weight to 100 parts by weight in total of components [A] and [B] is preferable.

Thermoplastic resin particles may also be used that have different particle diameters; two or more types of different thermoplastic resin particles may also be used. The mean particle diameter of the thermoplastic resin particles is preferably 5 to 30 μm. Particles having a size in this range are desirable, because this size can prevent loss of mechanical properties due to disruption of the fiber orientations when the material penetrates into the interior parts of the reinforcing fiber layer during infusion of the benzoxazine resin composition into the reinforcing fiber layer, or due to disruption of the reinforcing fiber layer by large undulations resulting from the presence of unfused particles in the resin layer between the reinforcing fiber layers.

Next, FRP (fiber-reinforced plastic) materials are described. By curing embodiments of the benzoxazine resin composition after impregnating reinforcing fibers with it, a FRP material that contains, as its matrix resin, embodiments of the benzoxazine resin composition in the form of a cured product may be obtained.

There are no specific limitations or restrictions on the type of reinforcing fiber used in the present invention, and a wide range of fibers, including glass fiber, carbon fiber, graphite fiber, aramid fiber, boron fiber, alumina fiber and silicon carbide fiber, may be used. Carbon fiber may provide FRP materials that are particularly lightweight and stiff. Carbon fibers with a tensile modulus of 180 to 800 GPa may be used, for example. If a carbon fiber with a high modulus of 180 to 800 GPa is combined with an benzoxazine resin composition of the present invention, a desirable balance of stiffness, strength and impact resistance may be achieved in the FRP material.

There are no specific limitations or restrictions on the form of reinforcing fiber, and fibers with diverse forms may be used, including, for instance, long fibers (drawn in one direction), tow, fabrics, mats, knits, braids, and short fibers (chopped into lengths of less than 10 mm). Here, long fibers mean single fibers or fiber bundles that are effectively continuous for at least 10 mm. Short fibers, on the other hand, are fiber bundles that have been chopped into lengths of less than 10 mm. Fiber configurations in which reinforcing fiber bundles have been aligned in the same direction may be suitable for applications where a high specific strength and specific modulus are required.

FRP materials of the present invention may be manufactured using methods such as the prepreg lamination and molding method, resin transfer molding method, resin film infusion method, hand lay-up method, sheet molding compound method, filament winding method and pultrusion method, though no specific limitations or restrictions apply in this respect.

Resin transfer molding is a method in which a reinforcing fiber base material is directly impregnated with a liquid thermosetting resin composition (such as the benzoxazine resin composition described herein) and cured. Since this method does not involve an intermediate product, such as a prepreg, it has great potential for molding cost reduction and is advantageously used for the manufacture of structural materials for spacecraft, aircraft, rail vehicles, automobiles, marine vessels and so on.

Prepreg lamination and molding is a method in which a prepreg or prepregs, produced by impregnating a reinforcing fiber base material with a thermosetting resin composition, is/are formed and/or laminated, followed by the curing of the resin through the application of heat and pressure to the formed and/or laminated prepreg/prepregs to obtain a FRP material.

Filament winding is a method in which one to several tens of reinforcing fiber rovings are drawn together in one direction and impregnated with a thermosetting resin composition as they are wrapped around a rotating metal core (mandrel) under tension at a predetermined angle. After the wraps of rovings reach a predetermined thickness, it is cured and then the metal core may or may not be removed.

Pultrusion is a method in which reinforcing fibers are continuously passed through an impregnating tank filled with a liquid thermosetting resin composition to impregnate them with the thermosetting resin composition, followed by a squeeze die and heating die for molding and curing, by continuously drawing them using a tensile machine. Since this method offers the advantage of continuously molding FRP materials, it is used for the manufacture of FRP materials for fishing rods, rods, pipes, sheets, antennas, architectural structures, and so on.

Of these methods, the prepreg lamination and molding method may be used to give excellent stiffness and strength to the FRP materials obtained.

Prepregs may contain embodiments of the benzoxazine resin composition and reinforcing fibers. Such prepregs may be obtained by impregnating a reinforcing fiber base material with a benzoxazine resin composition of the present invention. Impregnation methods include the wet method and hot melt method (dry method).

The wet method is a method in which reinforcing fibers are first immersed in a solution of a benzoxazine resin composition, created by dissolving the benzoxazine resin composition in a solvent, such as methyl ethyl ketone or methanol, and retrieved, followed by the removal of the solvent through evaporation via an oven, etc. to impregnate reinforcing fibers with the benzoxazine resin composition. The hot-melt method may be implemented by impregnating reinforcing fibers directly with a benzoxazine resin composition, made fluid by heating in advance, or by first coating a piece or pieces of release paper or the like with a benzoxazine resin composition for use as resin film and then placing a film over one or either side of reinforcing fibers as configured into a flat shape, followed by the application of heat and pressure to impregnate the reinforcing fibers with the resin. The hot-melt method may give the prepreg having virtually no residual solvent in it.

The reinforcing fiber cross-sectional density of a prepreg may be 50 to 350 g/m². If the cross-sectional density is at least 50 g/m², there may be a need to laminate a small number of prepregs to secure the predetermined thickness when molding a FRP material and this may simplify lamination work. If, on the other hand, the cross-sectional density is no more than 350 g/m², the drapability of the prepreg may be good. The reinforcing fiber mass fraction of a prepreg may be 50 to 90 mass % in some embodiments, 60 to 85 mass % in other embodiments or even 70 to 80 mass % in still other embodiments. If the reinforcing fiber mass fraction is at least 50 mass %, there is sufficient fiber content, and this may provide the advantage of a FRP material in terms of its excellent specific strength and specific modulus, as well as preventing the FRP material from generating too much heat during the curing time. If the reinforcing fiber mass fraction is no more than 90 mass %, impregnation with the resin may be satisfactory, decreasing a risk of a large number of voids forming in the FRP material.

To apply heat and pressure under the prepreg lamination and molding method, the press molding method, autoclave molding method, bagging molding method, wrapping tape method, internal pressure molding method, or the like may be used as appropriate.

Autoclave molding is a method in which prepregs are laminated on a tool plate of a predetermined shape and then covered with bagging film, followed by curing, performed through the application of heat and pressure while air is drawn out of the laminate. It may allow precision control of the fiber orientation, as well as providing high-quality molded materials with excellent mechanical characteristics, due to a minimum void content. The pressure applied during the molding process may be 0.3 to 1.0 MPa, while the molding temperature may be in the 90 to 300° C. range. Due to the exceptionally high Tg of the cured benzoxazine resin composition of the present invention, it may be advantageous to carry out curing of the prepreg at a relatively high temperature (e.g., a temperature of at least 180° C. or at least 200° C.). For example, the molding temperature may be from 200° C. to 275° C. Alternatively, the prepreg may be molded at a somewhat lower temperature (e.g., 90° C. to 200° C.), demolded, and then post-cured after being removed from the mold at a higher temperature (e.g., 200° C. to 275° C.).

The wrapping tape method is a method in which prepregs are wrapped around a mandrel or some other cored bar to form a tubular FRP material. This method may be used to produce golf shafts, fishing poles and other rod-shaped products. In more concrete terms, the method involves the wrapping of prepregs around a mandrel, wrapping of wrapping tape made of thermoplastic film over the prepregs under tension for the purpose of securing the prepregs and applying pressure to them. After curing of the resin through heating inside an oven, the cored bar is removed to obtain the tubular body. The tension used to wrap the wrapping tape may be 20 to 100 N. The molding temperature may be in the 80 to 300° C. range.

The internal pressure forming method is a method in which a preform obtained by wrapping prepregs around a thermoplastic resin tube or some other internal pressure applicator is set inside a metal mold, followed by the introduction of high pressure gas into the internal pressure applicator to apply pressure, accompanied by the simultaneous heating of the metal mold to mold the prepregs. This method may be used when forming objects with complex shapes, such as golf shafts, bats, and tennis or badminton rackets. The pressure applied during the molding process may be 0.1 to 2.0 MPa. The molding temperature may be between room temperature and 300° C. or in the 180 to 275° C. range.

The FRP material produced from the prepreg of the present invention may have a class A surface as mentioned above. The term “class A surface” means a surface that exhibits extremely high finish quality characteristics free of aesthetic blemishes and defects.

FRP materials that contain cured benzoxazine resin compositions obtained from benzoxazine resin compositions of the present invention and reinforcing fibers are advantageously used in sports applications, general industrial applications, and aeronautic and space applications. Concrete sports applications in which these materials are advantageously used include golf shafts, fishing rods, tennis or badminton rackets, hockey sticks and ski poles. Concrete general industrial applications in which these materials are advantageously used include structural materials for vehicles, such as automobiles, bicycles, marine vessels and rail vehicles, drive shafts, leaf springs, windmill blades, pressure vessels, flywheels, papermaking rollers, roofing materials, cables, and repair/reinforcement materials.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

The entire disclosure of each patent, published patent application or other publication mentioned herein is hereby incorporated by reference for all purposes.

### EXAMPLES

In the examples of the present invention, the measurements of the properties were based on the methods described below. The details for each of the examples are shown in Table 1.

### Resin Plaque Preparation

A mixture was created by dissolving the prescribed amounts of all the components other than the thermoplastic resin particles and polymerization catalyst in a mixture. Then the prescribed amounts of the thermoplastic resin particles and polymerization catalyst (if any) were introduced into the mixture to obtain the benzoxazine resin composition. The benzoxazine resin composition was dispensed into a mold cavity set for a thickness of 2 mm using a 2 mm-thick polytetrafluoroethylene (PTFE) spacer. Then, the benzoxazine resin composition was cured by heat treatment in an oven to obtain a 2 mm-thick cured resin plaque.

Cure Condition 1

(1) temperature raised at a rate of 1.5° C. /min from room temperature to 180° C.;

(2) hold for two hours at 180° C.;

(3) temperature raised at a rate of 1.5 ° C./min from 180° C. to 200° C.;

(4) hold for two hours at 200° C.;

(5) temperature raised at a rate of 1.5 ° C./min from 200° C. to 220° C.;

(6) hold for two hours at 220° C.; and

(7) temperature lowered from 220° C. to 30° C. at a rate of 3° C. /min.

### Measurement of Exothermic Reaction

The benzoxazine resin composition was prepared and the exothermic reaction energy (J/g) and exothermic peak temperature (° C.) (also referred to as peak reaction temperature) were measured according to ASTM D3418 using a differential scanning calorimeter (DSC) at 10° C./min. In the present invention exothermic reaction energy refers to the total area of the exothermic reaction peaks as calculated by integrating each peak (linear fit) and adding the total energy together. In the case of multiple peaks, they were integrated separately. In the case of overlapping peaks they were integrated as one. Peak reaction temperature refers to the temperature during the exothermic reaction peak when the absolute heat flow (W/g) is at its maximum.

### Measurement of Residual Exothermic Reaction

The benzoxazine resin composition was cured per Cure Condition 1 and the residual exothermic reaction energy (J/g) was measured according to ASTM D3418 using a differential scanning calorimeter (DSC) at 10° C./min.

### Glass Transition Temperature of Cured Benzoxazine Resin Compositions

Specimens were machined from the cured 2 mm resin plaque, and then measured at 1.0 Hz in torsion mode using a dynamic viscoelasticity measuring device (ARES, manufactured by TA Instruments) by heating it from 50° C. to 300° C. at a rate of 5° C./min in accordance with SACMA SRM 18R-94. The glass transition temperature (Tg) was determined by finding the intersection between the tangent line of the glassy region and the tangent line of the transition region between the glassy region and the rubbery region on the temperature-log elastic storage modulus curve.

The temperature at that intersection was considered to be the glass transition temperature, commonly referred to as G′ onset Tg. The wet glass transition temperature was determined in the same manner as the dry glass transition temperature except that the specimens were immersed in boiling deionized water for 24 hours before testing.

### Flexural Testing of Cured Benzoxazine Resin Compositions

Specimens were machined from the cured 2 mm resin plaque and the flexural modulus of elasticity and strength was measured in accordance with ASTM D-790. The hot/wet flexural modulus of elasticity and strength of the cured resin sheet at 180° C. were measured in the same manner as the room temperature properties except the specimens were immersed in boiling deionized water for 24 hours before testing.

### Raw Materials

The following commercial products and chemicals were employed in the preparation of the benzoxazine resin composition.

Component [A]:

“Araldite” MT35600 (registered trademark, produced by Huntsman Advanced Materials), bisphenol A-aniline type benzoxazine resin;

“Araldite” MT35900 (registered trademark, produced by Huntsman Advanced Materials), thiodiphenol type benzoxazine resin;

F-a (produced by Shikoku Chemicals Corp.), bisphenol F-aniline type benzoxazine resin;

P-d (produced by Shikoku Chemicals Corp.), phenol-diaminodiphenylmethane type benzoxazine resin.

Component [B]:

“Araldite” MY 0610 (registered trademark, produced by the Huntsman Corporation), triglycidyl meta-aminophenol trifunctional epoxy resin;

“Vinylcyclohexene dioxide” (produced by Alpha Chem Inc.), 1,2-Epoxy-4-(epoxyethyl)cyclohexane;

“Celloxide” 2021P (registered trademark, produced by Daicel Chemical Industries), 3,4-epoxycyclohexyl methyl 3,4-epoxycyclohexanecarboxylate;

“Celloxide” 2081P (registered trademark, produced by Daicel Chemical Industries), 3,4-Epoxycyclohexylmethyl-3′,4′-epoxycyclohexanecarboxylate modified epsilon-caprolactone; Bis(3,4-epoxycyclohexyl) (synthesized by the method described below):

First, 200 g of bicyclohexyl-3,3′-diene and 600 g of ethyl acetate were placed in a round bottom flask. Nitrogen gas was introduced to the flask and the temperature was controlled via oil bath at 38° C. Then, 225 g of a solution comprised of ethyl acetate, water (0.40% by weight) and peracetic acid (30% by weight) was added dropwise for about 3 hours. After the completion of dropwise addition of the solution, the resulting mixture was allowed to rest at 40° C. for 1 hour. The resulting liquid was then washed with water at 30° C., and then vacuum dried at 70° C. to remove any residual impurities. Finally, 201 g of an epoxy compound was obtained with a yield of 84%. 2,3-Bis(3,4-epoxycyclohexyl)oxirane (synthesized by the method described below):

First, 300 g of 4,4′-(1,2-ethenediyl)bis[cyclohexene] and 1000 g of ethyl acetate were placed in a round bottom flask. Nitrogen gas was introduced to the flask and the temperature was controlled via oil bath at 38° C. Then, 390 g of a solution comprised of ethyl acetate, water (0.40% by weight) and peracetic acid (30% by weight) was added dropwise for about 3 hours. After the completion of dropwise addition of the solution, the resulting mixture was allowed to rest at 40° C. for 1 hour.

The resulting liquid was then washed with water at 30° C., and then vacuum dried at 70° C. to remove any residual impurities. Finally, 272 g of an epoxy compound was obtained with a yield of 78%.

XU19127 (produced by The Olin Corporation), divinylbenzene diepoxide;

D81009 ALDRICH (produced by Sigma-Aldrich), dicyclopentadiene diepoxide. Component [C]:

“Matrimid” 9725 (registered trademark, produced by Huntsman Advanced Materials), polyimide;

“Virantage” VW10700 (registered trademark, produced by Solvay SA), polyethersulfone; “Virantage” VW30500 (registered trademark, produced by Solvay SA), polyethersulfone.

Component [D]:

104256 ALDRICH (produced by Sigma-Aldrich), ethyl p-toluenesulfonate;

Accelerator DT 300 (produced by the Huntsman Corporation), thiodiphenol.

Component [E]:

“Toraypearl” TN (registered trademark, produced by Toray Industries, Inc.), polyamide.

The benzoxazine resin compositions as shown in Table 1 and 2 were produced as follows. A mixture was created by dissolving the prescribed amounts of all the components other than the thermoplastic resin particles and polymerization catalyst in a mixture. Then the prescribed amounts of the thermoplastic resin particles and polymerization catalyst (if any) were introduced into the mixture to obtain the benzoxazine resin composition. The benzoxazine resin composition was dispensed into a mold cavity set for a thickness of 2 mm using a 2 mm-thick polytetrafluoroethylene (PTFE) spacer. Then, the benzoxazine resin composition was cured according to Cure Condition 1 by heat treatment in an oven to obtain a 2 mm-thick cured resin plaque. The measured properties of the neat resin compositions (in cured form) are stated in Table 1.

Examples 1 to 10 provided good results compared with Comparative Examples 1 to 8 in terms of glass transition temperature relative to curing temperature and retention of flexural modulus at elevated temperatures. Comparison between Example 7 and Comparative Example 5 highlights this advantage, demonstrating that a substitution of bis(3,4-epoxycyclohexyl), a cycloaliphatic epoxy, for MY0610, a glycidyl epoxy resin, resulted in significant improvements in the glass transition temperature in regards to both the final transition temperature and the improvement in Tg relative to the cure temperature. In addition the use of the cycloaliphatic epoxy, bis(3,4-epoxycyclohexyl), also increases the retention of the room temperature flexural modulus at elevated temperatures when compared with MY0610, a glycidyl epoxy resin. This is surprising given that the glycidyl epoxy resin is multifunctional and hence would be expected to yield a matrix with higher crosslink density, thus giving a higher glass transition temperature.

Comparison between Example 1 and Comparative Examples 3 and 10 highlights the importance of the low molecular weight linkage group in the cycloaliphatic epoxy resin, demonstrating that a substitution of bis(3,4-epoxycyclohexyl), a cycloaliphatic epoxy with a linkage group having a molecular weight less than 45 g/mol, for Celloxide® 2021P or Celloxide® 2081P, cycloaliphatic epoxy resins with linkage groups having molecular weights more than 45 g/mol, resulted in significant improvements in the glass transition temperature in regards to both the final transition temperature and the improvement in Tg relative to the cure temperature. In addition, the use of bis(3,4-epoxycyclohexyl) also significantly improved the retention of the flexural modulus at 180° C. after saturation with moisture when compared to the room temperature (21° C.) ambient flexural modulus.

Comparison between Example 10 and Comparative Example 8 demonstrates the importance of choosing the right polymerization catalyst for the multifunctional benzoxazine resin and cycloaliphatic epoxy resin. Example 10 demonstrated a high glass transition temperature and excellent modulus retention after saturation with moisture while Comparative Example 8 had a low glass transition temperature. This is a result of the polymerization catalyst used in Example 10, a sulfonate ester, decreasing the peak reaction temperature of the cycloaliphatic epoxy resin so that it is closer to that of the benzoxazine resin.

Comparison between Example 2 and Comparative Example 7 demonstrates that replacing a low molecular weight rigid cycloaliphatic epoxy resin, bis(3,4-epoxycyclohexyl), with a low molecular weight rigid glycidyl epoxy resin, XU19127, does not result in either the high glass transition temperature or the flexural modulus retention. In conjuncture with prior results, this result demonstrates that in order to achieve desirable high temperature properties, the epoxy resin used in the benzoxazine resin composition must have a rigid (relatively low molecular weight) linker group and must be cycloaliphatic.

TABLE 1

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| Benzoxazine | Araldite MT35 [symbol] 00 | 70 | 70 | 70 | 50 | 60 | | | | | |
| resin (A) | F-a | | | | | | 70 | 60 | 70 | | 70 |
| | Araldite MT35900 | | | | 20 | | | | | | |
| | P-d | | | | | | | | | 70 | |
| Epoxy resin | Bis(3,4-epoxycyclohexyl) | 30 | 30 | 15 | 30 | | 30 | 40 | 30 | 30 | |
| (B) | 2,3-Bis(3,4- | | | 15 | | 40 | | | | | |
| | epoxycyclohexyl) [symbol] ane | | | | | | | | | | |
| | D61009 ALDRICH | | | | | | | | | | 30 |
| Thermoplastic | Virantage [symbol] VW30500 | | 10 | 10 | 10 | 15 | 10 | 15 | | 10 | |
| compound (C) | Mat [symbol] 9725 | | | | | | | | 10 | | |
| Polymerization | 104256 ALDRICH | | | | | | | | | | 2 |
| catalyst (D) | | | | | | | | | | | |
| Uncured Resin | Number of Reaction Peaks | 1 | 1 | 1 | 1 | 1 | 1 | 1 | 1 | 1 | 2 |
| properties | Temperature of Reaction Peak#1 | 241 | 244 | 240 | 242 | 249 | 241 | 251 | 245 | 250 | 217 |
| | (° C.) | | | | | | | | | | |
| | Temperature of Reaction Peak#2 | NA | NA | NA | NA | NA | NA | NA | NA | NA | 250 |
| | (° C.) | | | | | | | | | | |
| | Difference in Temperature of | NA | NA | NA | NA | NA | NA | NA | NA | NA | 33 |
| | Reaction Peaks (° C.) | | | | | | | | | | |
| Resin | Glass Transition temperature (° C.) | 240 | 244 | 245 | 233 | 240 | 237 | 230 | 236 | 235 | 242 |
| properties | Glass Transiton temperature H/W | 220 | 221 | 220 | 217 | 213 | 215 | 207 | 217 | 208 | 219 |
| | (° C.) | | | | | | | | | | |
| | Flexural modulus of elasticity (GPa) | 4.55 | 4.51 | 4.42 | 4.43 | 4.15 | 4.54 | 4.32 | 4.71 | 3.89 | 5.48 |
| | Flexural modulus of elasticity @ | 2.05 | 2.01 | 1.75 | 1.88 | 1.65 | 2.00 | 1.8 | 2.3 | 2.08 | 2.24 |
| | 180° C. after saturation with | | | | | | | | | | |
| | moisture(GPa) | | | | | | | | | | |

[symbol]

indicates data missing or illegible when filed

TABLE 2

| | | Comparative | Comparative | Comparative | Comparative | Comparative |
|---|---|---|---|---|---|---|
| | | Example 1 | Example 2 | Example 3 | Example 4 | Example 5 |
| Benzoxazine | Araldite MT35500 | 70 | 70 | 70 | | |
| resin (A) | F-a | | | | 70 | 60 |
| | P-d | | | | | |
| Epoxy resin (B) | Celloxide [symbol] 202 [symbol] P | 30 | 30 | 30 | 30 | |
| | Celloxide [symbol] 208 [symbol] P | | | | | |
| | XU19127 | | | | | |
| | dicyclopentadiene diepoxide | | | | | |
| | Vinylcyclohexane dioxide | | | | | |
| | Araldite [symbol] MY0 [symbol] 10 | | | | | 40 |
| Thermoplastic | Virantage [symbol] VW10 [symbol] 00 | | | | | 15 |
| compound [symbol] C [symbol] | Virantage [symbol] VW90500 | 10 | | | | |
| | Mat [symbol] 9725 | | 10 | | | |
| Polymerization | DT300 | | | | | |
| catalyst (D) | | | | | | |
| Uncured Resin | Number of Reaction Peaks | 1 | 1 | 1 | 1 | 1 |
| properties | Temperature of Reaction Peak#1 (° C.) | 242 | 244 | 238 | 240 | 251 |
| | Temperature of Reaction Peak#2 (° C.) | NA | NA | NA | NA | NA |
| | Difference in Temperature of Reaction | NA | NA | NA | NA | NA |
| | Peaks (° C.) | | | | | |
| Cured Resin | Glass Transition temperature (° C.) | 225 | 223 | 215 | 210 | 193 |
| properties | Glass Transiton temperature H/W (° C.) | 200 | 203 | 195 | 189 | 168 |
| | Flexural modulus of elasticity (GPa) | 4.59 | 4.8 | 4.78 | 4.81 | 4.99 |
| | Flexural modulus of elasticity @ 180° C. | 1.16 | 1.35 | 1.21 | 1.20 | 0.82 |
| | after saturation with moisture(GPa) | | | | | |
| | | Comparative | Comparative | Comparative | Comparative | Comparative |
| | | Example 6 | Example 7 | Example 8 | Example 9 | Example 10 |
| Benzoxazine | Araldite MT35500 | | | | | |
| resin (A) | F-a | | 70 | 80 | 75 | 55 |
| | P-d | 70 | | | | |
| Epoxy resin (B) | Celloxide [symbol] 202 [symbol] P | 30 | | | | |
| | Celloxide [symbol] 208 [symbol] P | | | | | 45 |
| | XU19127 | | 30 | | | |
| | dicyclopentadiene diepoxide | | | 20 | | |
| | Vinylcyclohexane dioxide | | | | 25 | |
| | Araldite [symbol] MY0 [symbol] 10 | | | | | |
| Thermoplastic | Virantage [symbol] VW10 [symbol] 00 | | | | | |
| compound [symbol] C [symbol] | Virantage [symbol] VW90500 | 10 | 10 | | | |
| | Mat [symbol] 9725 | | | | | |
| Polymerization | DT300 | | | 16 | | |
| catalyst (D) | | | | | | |
| Uncured Resin | Number of Reaction Peaks | 1 | 2 | 2 | 1 | 1 |
| properties | Temperature of Reaction Peak#1 (° C.) | 253 | 151 | 205 | 244 | 265 |
| | Temperature of Reaction Peak#2 (° C.) | NA | 256 | 312 | NA | NA |
| | Difference in Temperature of Reaction | NA | 105 | 107 | NA | NA |
| | Peaks (° C.) | | | | | |
| Cured Resin | Glass Transition temperature (° C.) | 227 | 173 | 154 | 169 | 140 |
| properties | Glass Transiton temperature H/W (° C.) | 205 | 155 | 142 | 141 | 112 |
| | Flexural modulus of elasticity (GPa) | 4.4 | 4.71 | 6.26 | 4.70 | 3.93 |
| | Flexural modulus of elasticity @ 180° C. | 1.24 | 0.84 | 0.10 | 0.45 | 0.26 |
| | after saturation with moisture(GPa) | | | | | |

[symbol]

indicates data missing or illegible when filed

1. A benzoxazine resin composition for a fiber-reinforced composite material, comprising a component [A] having a peak reaction temperature and a component [B] having a peak reaction temperature, wherein:
a) the peak reaction temperatures of component [A] and component [B] as measured in the benzoxazine resin composition by differential scanning calorimetry are within 50° C. of each other;
b) component [A] comprises at least one multifunctional benzoxazine resin;
c) component [B] comprises at least one cycloaliphatic epoxy resin represented by Formula (I): 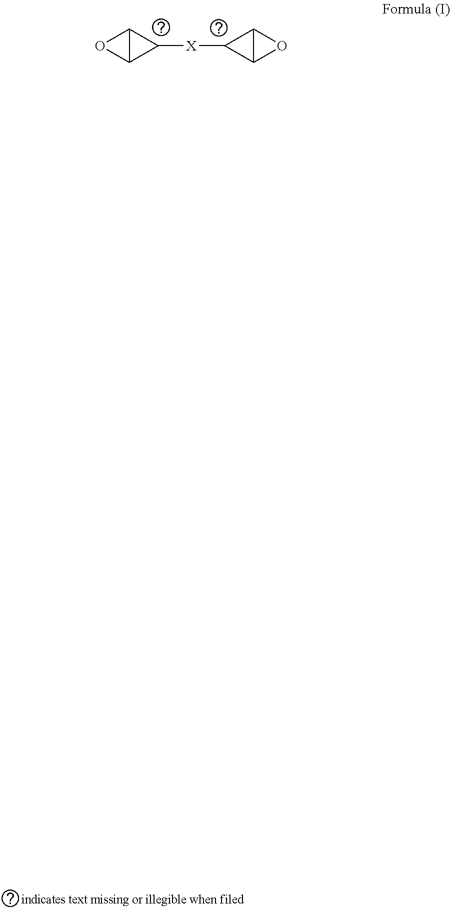
wherein R₁ and R₂ are the same or different and are each an aliphatic moiety which together with carbon atoms of an epoxy group form at least one aliphatic ring and X is optionally present, wherein when X is present X represents a single bond or a divalent moiety having a molecular weight less than 45 g/mol and when X is not present the cycloaliphatic epoxy resin comprises fused aliphatic rings involving R₁ and R₂; and
d) when the peak reaction temperatures of component [A] and component [B] as measured in the benzoxazine resin composition by differential scanning calorimetry in the absence of a polymerization catalyst are not within 50° C. of each other, the benzoxazine resin composition additionally comprises a component [D] comprised of a polymerization catalyst which is effective to bring the peak reaction temperatures of component [A] and component [B] as measured by differential scanning calorimetry in the benzoxazine resin composition to within 50° C. of each other.

2. The benzoxazine resin composition according to claim 1, wherein component [A] comprises at least one multifunctional benzoxazine resin comprising two or more structural units as represented by general Formula (II): 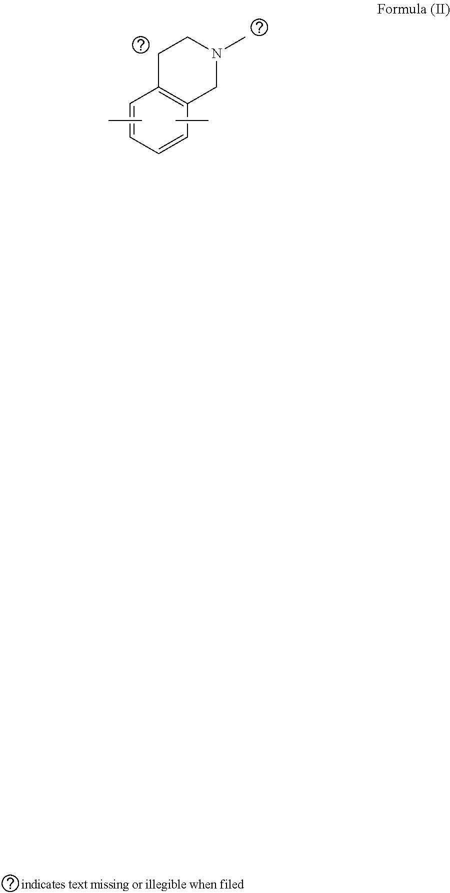
wherein R₁ denotes a linear alkyl group with a carbon number of 1 to 12, a cyclic alkyl group with a carbon number of 3 to 8, a phenyl group, or a phenyl group that is substituted with a linear alkyl group having a carbon number of 1 to 12 or a halogen, with a hydrogen being bonded to at least one of the carbon atoms at the ortho-position and the para-position with respect to a carbon atom to which an aromatic-ring oxygen atom is bonded.

3. The benzoxazine resin composition according to claim 1, wherein component [B], when analyzed individually by differential scanning calorimetry at a ramp rate of 10° C./min exhibits a peak exotherm at a higher temperature than a mixture of component [A], [B] and optionally [D].

4. The benzoxazine resin composition according to claim 1, wherein component [A] and component [B] are present in amounts effective to provide an equivalent ratio of [A_{eg}]/[B_{eg}] of 0.5 to 2.5 and where [A_{eg}]=equivalents of benzoxazine functional groups in component [A] and [B_{eg}]=equivalents of epoxy groups in component [B].

5. The benzoxazine resin composition according to claim 2, wherein component [B] includes at least one cycloaliphatic epoxy resin represented by Formula (I), wherein X is not present, a single bond, O, S, CH₂, C(CH₃)₂, or an oxirane ring.

6. The benzoxazine resin composition according to claim 2, wherein component [B] includes at least one cycloaliphatic epoxy resin represented by Formula (I), wherein R₁ and R₂ are each independently part of a cyclopentane ring, a cyclohexane ring, or a bicycloheptane ring.

7. The benzoxazine resin composition according to claim 1, further comprising a component [C], wherein component [C] comprises a thermoplastic compound comprising one or more repeating units.

8. The benzoxazine resin composition according to claim 7, wherein the thermoplastic compound has a glass transition temperature of at least 150° C.

9. The benzoxazine resin composition according to claim 8, wherein the thermoplastic compound is a polyethersulfone or polyimide.

10. The benzoxazine resin composition according to claim 9, wherein the polyimide thermoplastic compound is a polyimide having a backbone which additionally contains phenyltrimethylindane or phenylindane units.

11. The benzoxazine resin composition according to claim 1, wherein component [D] is present.

12. The benzoxazine resin composition according to claim 11, wherein component [D] comprises a sulfonate ester.

13. The benzoxazine resin composition according to claim 1, further comprising a component [E], wherein the component [E] comprises thermoplastic resin particles with an average particle diameter of 5 to 30 μm.

14. The benzoxazine resin composition according to claim 1, wherein component [A] is comprised of a component [A1] and a component [A2] which are different from each other.

15. The benzoxazine resin composition according to claim 1, wherein component [B] is comprised of a component [A1] and a component [B2] which are different from each other.

16. The benzoxazine resin composition according to claim 1, wherein when the benzoxazine resin composition is cured to provide a cured matrix having a glass transition temperature, the glass transition temperature of the cured matrix is at least 10° C. higher than the highest curing temperature as determined by the G′ onset method.

17. The benzoxazine resin composition according to claim 1, wherein when the benzoxazine resin composition is cured at a temperature equal to or less than 220° C. to provide a cured matrix having a glass transition temperature, the glass transition temperature of the cured matrix after exposure to moisture is at least 205° C. as determined by the G′ onset method.

18. The benzoxazine resin composition according to claim 1, wherein when the benzoxazine resin composition is cured to provide a cured matrix having a flexural modulus of elasticity, the flexural modulus of elasticity of the cured matrix at 180° C. after exposure to moisture is at least 30% of the flexural modulus of elasticity of the cured matrix at room temperature under ambient conditions as determined by the three point bend method.

19. A prepreg, comprising a reinforcing fiber matrix impregnated with a benzoxazine resin composition in accordance with claim 1.

20. A fiber-reinforced composite material obtained by curing a prepreg in accordance with claim 19.

21. A fiber-reinforced composite material, comprising a cured matrix obtained by curing a mixture comprised of a benzoxazine resin composition in accordance with claim 1 and a reinforcing fiber.

22. A method of making a benzoxazine resin composition, wherein the method comprises:
a) selecting a component [A] having a peak reaction temperature as measured by differential scanning calorimetry and comprising at least one multifunctional benzoxazine resin;
b) selecting a component [B] having a peak reaction temperature as measured by differential scanning calorimetry and comprising, consisting essentially of or consisting of at least one cycloaliphatic epoxy resin represented by Formula (I): 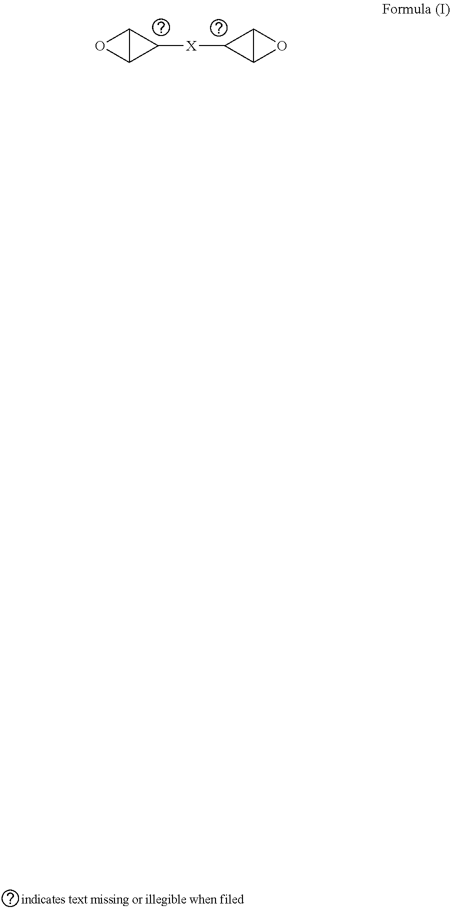
wherein R₁ and R₂ are the same or different and are each an aliphatic moiety which together with carbon atoms of an epoxy group form at least one aliphatic ring and X is optionally present, wherein when X is present X represents a single bond or a divalent moiety having a molecular weight less than 45 g/mol and when X is not present the cycloaliphatic epoxy resin comprises fused aliphatic rings involving R₁ and R₂; and
c) combining at least component [A] and component [B] to obtain the benzoxazine resin composition;
wherein a component [D] comprised of a polymerization catalyst which is effective to bring the peak reaction temperatures of component [A] and component [B] to within 50° C. of each other is additionally combined with component [A] and component [B] if the peak reaction temperatures of component [A] and component [B] in the benzoxazine resin composition as measured by differential scanning calorimetry are not within 50° C. of each other in the absence of the polymerization catalyst.
